(19) United States
(12) Patent Application Publication
(10) Pub. No.: US 2008/0236739 A1
(43) Pub. Date: Oct. 2, 2008

(54) Method of applying a constrained layer damping material

(75) Inventor: Duncan E. Ashley, Bristol (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 11/979,879

(22) Filed: Nov. 9, 2007

(30) Foreign Application Priority Data
Dec. 5, 2006 (GB) 0624251.5

(51) Int. Cl. B29C 65/48

(52) U.S. Cl. 156/285; 156/60; 156/332

(57) ABSTRACT

In a method of applying a constrained layer damping material 18 to a component 16, the material 18 is placed on the component 16, and pressure is applied over substantially the entire area of the material 18 for not less than 5 minutes and not more than 8 hours, the pressure being not less than 34 kPa, and the temperature being maintained at not less 80° C. and not more than 180° C. for the duration of the application of pressure.

This invention relates to a method of applying a constrained layer damping material to a component, and is particularly, although not exclusively, concerned with the application of a constrained layer damping material to a component of a gas turbine engine, such as an aerofoil component of a gas turbine compressor.

A gas turbine compressor comprises rotating blades and stationary vanes which may be slender components which are cantilevered at one or both ends. Such components are susceptible to forced vibrations, usually excited by the gas flow through the compressor. Such forced vibrations are typically likely to arise when the engine is running at the extremes of its operating envelope.

It is known to apply a constrained layer damping system to such components. A constrained layer damping system comprises a damping material sandwiched between the surface of the component and a constraining layer. The damping material may be bonded by means of a separate adhesive to the component and to the constraining layer, but in the aerospace industry it is common for the damping material itself to be an adhesive, so that the damping material forms an adhesive bond between the component and the constraining layer. For example, the damping material may comprise an acrylic polymer based visco-elastic damping adhesive. The constrained layer damping system may be supplied as a sheet or web material comprising the constraining layer with the damping adhesive applied, a peelable release film extending over the surface of the damping adhesive away from the constraining layer. Such material is commonly referred to as “damping foil”.

In a known technique for applying a constrained layer damping (CLD) system, a piece of the material is cut to shape, and then the release film is removed and the material is applied to the component to be damped, with the damping adhesive in contact with the surface of the component. The material can be applied by hand or by machine, and pressure may be applied by rollers in order to bond the material securely to the component. The application process may take place at elevated temperature, in order to enhance bonding.

With known techniques, it is difficult to achieve consistency in the application of the CLD material, particularly when the material is applied to components having a complex geometry, such as compressor vanes. When the material is applied to component surfaces having a complex or variable curvature, residual peel stresses arise in the CLD material which can cause local de-bonding from the component. This can cause an incorrect aerodynamic profile on the component surface, degrading engine performance and handling characteristics. If a local de-bond propagates, partial or wholesale loss of the CLD material can arise, leaving the component inadequately damped.

According to the present invention there is provided a method of applying a constrained layer damping material to a component, the constrained layer damping material comprising a constraining layer and an adhesive, the method comprising:
(i) placing the constrained layer damping material on the component with the adhesive between the component and the constraining layer; and
(ii) applying pressure to the constraining layer, characterised in that the pressure is applied over substantially the entire area of the constraining layer.

Preferably the pressure is not less than 30 kPa and is applied for a time which is not less than 5 minutes and not more than 8 hours, the adhesive being maintained at a temperature of not less than 80° C. and not more than 180° C. for at least part of the duration of the application of pressure.

The adhesive may be a damping adhesive.

The adhesive may comprise an acrylic polymer.

The pressure applied to the constraining layer may be not greater than 1000 kPa and, in a particular method in accordance with the present invention lies in the range 600 to 800 kPa, more particularly 680 to 700 kPa.

The pressure may be applied for a time which is not less than 1 hour and not more than 2 hours. The damping adhesive may be maintained at a temperature not more than 120° C.

The constraining layer may comprise any material having a stiffness great enough to constrain the damping adhesive and/or a layer of damping material in order to cause the constrained layer damping material to provide sufficient damping. The constraining layer may, for example, be made from stainless steel, aluminium or aluminium alloy, a thermoplastic material or a glass or carbon fibre composite.

The method may be carried out by placing the component, with the constrained layer damping material in position on the component, in a chamber which is maintained at the required temperature and pressure, for the required time. Before the component is placed in the chamber, a liner may be applied over the constraining layer. The liner may be in the form of a bag of flexible material which accommodates the entire component, and the bag may be evacuated before pressure is applied to the constraining layer in order to bring the material of the bag into close contact with the constraining layer.

In an alternative method, the pressure may be applied by means of a press member having a press surface which conforms to the surface profile of the constrained layer damping material after application. The press member may have a resilient lining defining the press surface. The press member may have heating means for heating the damping adhesive during the application of pressure.

For a better understanding of the present invention, and to show more clearly how it may be carried into effect, reference will now be made, by way of example, to the accompanying drawings, in which:

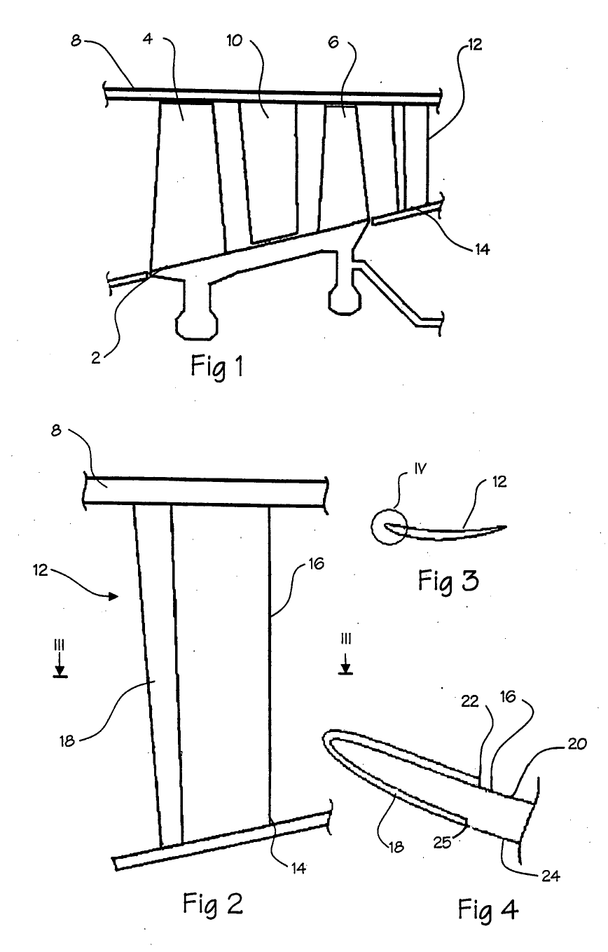

FIG. 1 is a diagrammatic view of a compressor stage of a gas turbine engine;

FIG. 2 shows a vane of the compressor stage of FIG. 1;

FIG. 3 is a sectional view taken on the line III-III in FIG. 2;

FIG. 4 is an enlarged view of the region IV in FIG. 3;

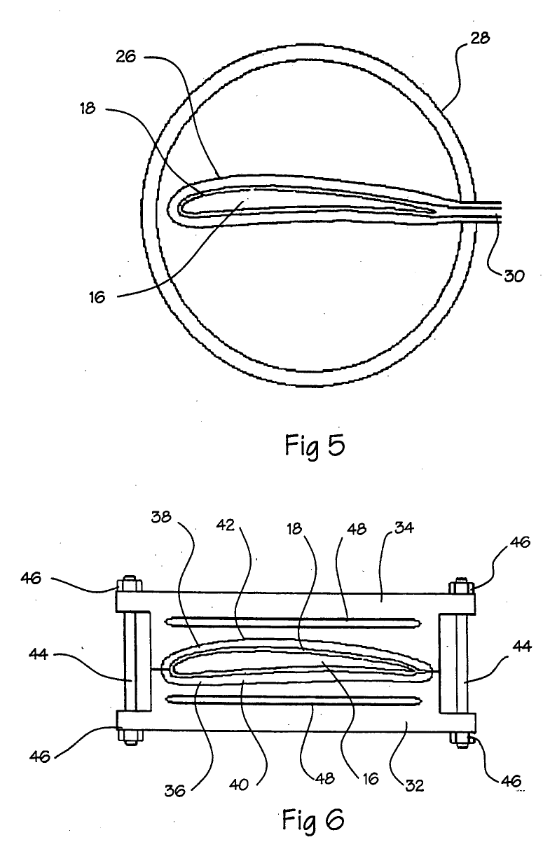

FIG. 5 is a diagrammatic view of a pressure chamber for use in the application of a constrained layer damping material to the vane of FIG. 2; and

FIG. 6 shows a press suitable for use in an alternative method of applying the constrained layer damping material to the vane.

FIG. 1 shows a rotor 2 carrying compressor blades 4 and 6. The blades 4 and 6 rotate within a casing 8, and a row of stator vanes 10 is disposed between the blades 4 and 6. Each vane 10 is cantilevered at its outer end from the casing 8. A further row of stator vanes 12 is situated downstream of the blades 4 and 6, with respect to the direction A of gas flow through the compressor. Each vane 12 extends between the casing 8 and an inner casing 14, and is cantilevered at both ends. The blades 4 and 6 and the vanes 10 and 12 may be made from any suitable material, including aerospace alloys and composite materials, in particular carbon reinforced composite materials. One of the vanes 12 is shown on a larger scale in FIG. 2. The vane comprises a body 16 having an aerodynamic profile, to which is applied a constrained layer damping system comprising a constrained layer damping material 18 in the form of damping foil.

As shown in FIG. 4, the damping foil is in the form of a layer which extends around the leading edge of the vane 12, and extends for some distance from the leading edge down the pressure and suction sides 20, 24 of the vane 12. The surface of the body 16 may be continuous, as indicated in FIG. 4 for the pressure side 20, so that the outer surface of the damping foil 18 stands proud of the surface of the body 16 at its edge 22. Alternatively, as indicated for the suction side 24 in FIG. 4, the body 16 may be recessed so that the outer surface of the damping foil 18 is flush with the surface of the vane 16 at its edge 25.

Although not shown in FIGS. 1 to 4, the damping foil 18 comprises a constraining layer, which forms the outer surface of the damping foil 18 when applied to the component 16, and a damping adhesive, which may be an acrylic polymer, which, when applied to the component 16 is sandwiched between the constraining layer and the surface of the component 16. The damping adhesive thus serves the dual purpose of providing a visco-elastic damping effect, and of bonding the constraining layer to the component 16.

One method of applying the damping foil 18 to the body 16 of the vane 12 is illustrated in FIG. 5. The damping foil 18 is supplied as a pre-formed composite consisting of the constraining layer with the damping adhesive applied over the full extent of one surface. The surface of the damping adhesive away from the constraining layer is provided with a release film. A piece of the damping foil 18 is cut accurately to size from a sheet or web of the material as supplied, and preformed approximately to the required shape. The body 16 of the vane 12 is cleaned and any necessary surface treatments, such as grit blasting or etching are carried out. The backing layer or release film is then peeled from the cut and formed piece of damping foil 18, which is then applied to the body 16. The entire vane, with the damping foil 18 applied, is then sealed within a vacuum bag 26 and placed in an autoclave 28. The vacuum bag is connected by a tube 30 to the exterior of the autoclave 28, and the bag 26 is then evacuated by means of a vacuum pump connected to the tube 30 to bring the bag into intimate contact with the exterior of the damping foil 18. The autoclave 28 is then pressurised, and the temperature within it is raised to a predetermined pressure and temperature, and the curing of the damping adhesive is allowed to proceed for a predetermined time. At the end of the curing process, the component is allowed to cool and is removed from the autoclave 28 and the vacuum bag 26.

It will be appreciated that the process described above results in the elevated pressure being applied over the full extent of the surface of the damping foil 18, in contrast to the known process in which local pressure is applied intermittently by way of rollers. Furthermore, because the process is conducted within the autoclave 28, the temperature can be maintained at a controlled level throughout the curing process. Consequently, an improved and consistent bond between the damping foil 18 and the body 16 can be achieved.

FIG. 6 illustrates a press for use in an alternative method of applying the damping foil 18 to the body 16. In the method as carried out in the press of FIG. 6, the cutting to shape and forming of the damping foil 18, and the cleaning of the body 16, are carried out as before. However, the vacuum bag 26 is not used, and instead the component is placed between two press members 32, 34 made from a substantially rigid material such as tool steel, aluminium or hard plastics material. The press members 32, 34 have press surfaces 36, 38 having shapes which are complementary to that of the finished vane 12. The press surfaces 36, 38 are provided on respective resilient liners 40, 42 which are made, for example, from silicone rubber.

The body 16, with the damping foil 18 applied, is placed between the press members 32, 34, which are then drawn together by means of tie bars 44 and nuts 46 to apply pressure to the damping foil 18. The resilient liners 40, 42 serve to even out the pressure applied by the press members 32, 34, so as to apply a consistent pressure over the full extent of the surface of the damping foil 18.

Heater elements 48 are incorporated into the press members 32, 34, so that the entire press, and the body 16 and the damping foil 18, can be raised to the temperature required for curing of the damping adhesive. Alternatively, external heating means could be provided, for example by placing the assembled press in an oven. Suitable means, such as thermocouples, may be provided within the press members 32, 34 to monitor the cure temperature.

It will be appreciated that, for purposes of illustration, the damping foil 18 is shown as extending over the entire surface of the body 16 in FIGS. 5 and 6, whereas in FIGS. 2 and 4 the damping foil 18 is provided only at the leading edge region of the vane 12. In a specific process in accordance with the present invention, a damping foil 18 is used which comprises a constraining layer of stainless steel having a thickness of 0.05 mm. The damping adhesive comprises a visco-elastic polymer available under the designation HIP2 from Heathcote Industrial Plastics Limited of Newcastle-under-Lyme, Staffordshire, UK. The damping foil is applied to a compressor vane made from carbon reinforced composite material. After application of the damping foil 18 comprising the constraining layer and the damping adhesive, the component was subjected to a pressure in the range 680 kPa to 700 kPa, specifically 690 kPa, over the entire surface of the constraining layer at a temperature of in the range 90° C. to 110° C., specifically 100° C., for a duration in the range 80 to 100 minutes, specifically 90 minutes.

Cutting out of the pieces of the damping foil 18 may be performed using templates, stamping machines or CNC machines, in order to provide pieces of consistent shape. Although, as described above, a single piece of the damping foil 18 could be used for each component, it is also possible for each component to be provided with a plurality of pieces of the damping foil 18, in order to allow the material to conform better to complex geometry.

As described above, the damping adhesive serves both to damp vibrations excited in the component and to bond the damping foil 18 to the component. In some circumstances, it may be desirable for a “tackifier” film to be applied to the surface of the component 16 after any surface preparation processes and before application of the damping foil 18, in order to improve the strength of the bond between the damping foil 18 and the component 16. Improved initial bonding can also be achieved by pre-heating the component before application of the damping foil 18. In some circumstances, the damping adhesive may be excessively tacky in ambient conditions, causing difficulties positioning and seating the damping foil 18 on the component without sticking prematurely. To avoid this, it may be desirable for the damping foil 18 to be pre-chilled before application to the component.

In the embodiments of FIGS. 5 and 6, it may be desirable to place one or more peel plies of a suitable film between the vacuum bag 26 (or the linings 40, 42) and the damping foil 18 in order to prevent unwanted adhesion when removing the components with the cured damping adhesive from the vacuum bag 26 or the press members 32, 34.

The constraining layer may be formed so as to serve as a relatively stiff erosion shield.

1. A method of applying a constrained layer damping material to a component the constrained layer damping material comprising a constraining layer and an adhesive, the method comprising:
(i) placing the constrained layer damping material on the component with the adhesive between the component and the constraining layer; and
(ii) applying pressure to the constraining layer, wherein the pressure is applied over substantially the entire area of the constraining layer.

2. A method as claimed in claim 1 wherein the pressure is not less than 30 kPa, and is applied for a time which is not less than 5 minutes and not more than 8 hours, the adhesive being maintained at a temperature of not less than 80° C. and not more than 180° C. for at least part of the duration of the application of pressure.

3. A method as claimed in claim 1, wherein the adhesive is a damping adhesive.

4. A method as claimed in claim 1, wherein the adhesive comprises an acrylic polymer.

5. A method as claimed in claim 1, wherein the pressure applied to the constraining layer is not greater than 1000 kPa.

6. A method as claimed in claim 5, wherein the pressure applied to the constraining layer is not less than 600 kPa and not more than 800 kPa.

7. A method as claimed in claim 1, in which the duration of the application of pressure is not less than 1 hour and not more than 2 hours.

8. A method as claimed in claim 1, wherein the adhesive is maintained during application of pressure at a temperature not greater than 120° C.

9. A method as claimed in claim 1, wherein the constraining layer comprises stainless steel, aluminium, aluminium alloy, thermoplastic material, or glass or carbon fibre composite material.

10. A method as claimed in claim 1, in which the step of applying pressure to the constraining layer is performed in a chamber, the interior of which is maintained at a predetermined temperature and pressure.

11. A method as claimed in claim 10, wherein, after the constrained layer damping material is placed on the component, the component is placed within a bag before the component and the bag are placed in the chamber, the bag being evacuated prior to the application of pressure to the constraining layer.

12. A method as claimed in claim 1, wherein the pressure is applied to the constraining layer by a press member having a press surface conforming to the surface profile of the constrained layer damping material after application to the component.

13. A method as claimed in claim 12, wherein the press member has a resilient lining defining the press surface.

14. A method as claimed in claim 12, wherein the press member is provided with heating means.

15. A method as claimed in claim 1, wherein the constraining layer comprises stainless steel having a thickness of 0.05 mm, the component is a moulded carbon fibre composite component, and the adhesive comprises an acrylic polymer, the pressure applied to the constraining layer being not less 680 kPa and not more than 700 kPa, the duration of the application of pressure being not less than 80 minutes and not more than 100 minutes, and the adhesive being maintained at a temperature of not less 90° C. and not more than 110° C. for the duration of the application of pressure.

16. A method as claimed in claim 1, wherein the component is an aerofoil component of a gas turbine engine.

17. A method as claimed in claim 15, wherein the component is a compressor vane.
